(19) United States
(12) Patent Application Publication
(10) Pub. No.: US 2005/0010641 A1
(43) Pub. Date: Jan. 13, 2005

(54) Instant messaging context specific advertisements

(76) Inventor: Jens Staack, Kirkkonummi (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/447,993

(22) Filed: May 30, 2003

(30) Foreign Application Priority Data
Apr. 3, 2003 (EP) 03007708.5

(51) Int. Cl. G06F 15/16

(52) U.S. Cl. 709/206

(57) ABSTRACT

The invention proposes a method for providing context-related information, comprising the steps of analysing (S1, S2) whether a message contains a predetermined expression, and in case the predetermined expression is contained in the message, generating (S4) a predetermined information based on the predetermined expression. The invention also proposes a corresponding network system.

### FIELD OF THE INVENTION

This invention relates to a method and a system for providing messages service.

### BACKGROUND OF THE INVENTION

The invention relates to messages services, and in particular to the Instant Messaging and Presence Service (IMPS) which is currently standardised in many standardisation bodies and forums. Examples are OMA (Open Mobile Alliance, former Wireless Village), 3GPP Presence and IMS messaging, IETF SIMPLE, Jabber, etc. There are also defacto Instant Messaging and presence services already offered by several service providers (e.g., AOL, Microsoft, Yahoo and many others).

They all have more or less the same service principle: Users log on to the instant messaging service and presence service and they can see if intended subscribers, i.e., their buddies (indicated on a so-called buddy list) are online and willing to chat with them. Many services also offer the possibility to create chat rooms (by users or by administrators) in order to chat, e.g. about a certain topic. These could be e.g. a football club, the weather, stock market, etc.

Service providers who are offering those IMPS services, can charge the user in the following ways:
transmitted/received bytes (transport charging)
charging per message

This applies for fixed and wireless IMPS service offerings.

Additional revenues can be achieved, e.g. if the IMPS client or the browsers web page offers banner advertisement possibilities. Example: Yahoo stock market chat room could have banner advertisement for a broker (OPStock).

Although in this way some services are offered, there is still need to further expand the possibilities of services.

### SUMMARY OF THE INVENTION

Thus, the object underlying the present invention resides in providing additional service possibilities in messages services.

According to the invention, this object is solved by a method for providing context-related information, comprising the steps of
analysing whether a message contains a predetermined expression, and,
in case the predetermined expression is contained in the message, generating a predetermined information based on the predetermined expression.

Alternatively, the above object is solved by a network element for providing messages services, comprising
means for analysing whether a message received from a subscriber contains a predetermined expression and deciding whether the expression is contained in the message, and
means for generating predetermined information based on the predetermined expression.

Thus, according to the invention a message is searched for predetermined expressions, such as keywords or the like. When a predetermined expression is present in the message, predetermined information is generated. Such predetermined information may be advertisement, for example.

Thus, according to the present invention a new way of achieving additional service is provided. For example, new advertisement revenues for IMPS service providers may be obtained.

For example, the invention is applicable on chat room messages. In this way, chat room specific advertisement and chat topic context specific advertisements are enabled.

The predetermined expression may comprise a specific word or a specific word combination. Moreover, the predetermined expression may comprise a logic combination of different specific words or different specific word combinations. When logically combining the expressions, the predetermined information to be generated can be very individual.

The message may be sent from a user equipment (such as a mobile phone, a PDA, a PC or the like) of a subscriber, and the predetermined information may be sent to the user equipment. That is, the originator of the message receives the predetermined information (such as an advertisement or general information). The predetermined information may be displayed on a display means of the user equipment.

Furthermore, a plurality of user equipments of a plurality of subscribers may be involved in a communication during which the message is sent. This can be a chat in a chat room, for example. In this case, the predetermined information may be sent to all or a part of the plurality of user equipments.

The message may be a text message, a multimedia message, but can also be a voice message or the like.

On generating the predetermined information, the key expression may be sent to a specific information server, which determines whether a specific information is associated to the received key expression. In case a specific information is associated to the received key expression, the specific information may be output as the predetermined information.

That is, the network element performing the method according to the invention may contact a specific information server, which may be an advertisement server. Based on the received key words, the advertisement server may provide an advertisement based on the keywords.

Moreover, the predetermined expression may be stored in a database. Then, during analysing step whether the predetermined expression is contained in the message, the database is accessed.

The predetermined information may be generated only after it has been determined that the predetermined expression is contained in the message for a predetermined number of time. In this way, the predetermined information, e.g., advertisement, is not generated on every occurrence but only after the predetermined expression has occurred for several times. Thus, it is possible to avoid an undesired advertisement in case the predetermined expression is a rather common word, for example.

### BRIEF DESCRIPTION OF THE DRAWINGS

FIG. 1 shows a flow chart of the general procedure according to an embodiment of the invention,

FIG. 2 shows an IMPS architecture according to the embodiment of the present invention, and

FIG. 3 shows a more detailed procedure according to the embodiment of the present invention.

### DESCRIPTION OF THE PREFERRED EMBODIMENTS

In the following, preferred embodiments are described by referring to the enclosed drawings.

As described above, according to the invention a new way of achieving additional service and, e.g., advertisement revenues for messaging service (e.g., IMPS (Instant Messaging and Presence Service) service providers are possible.

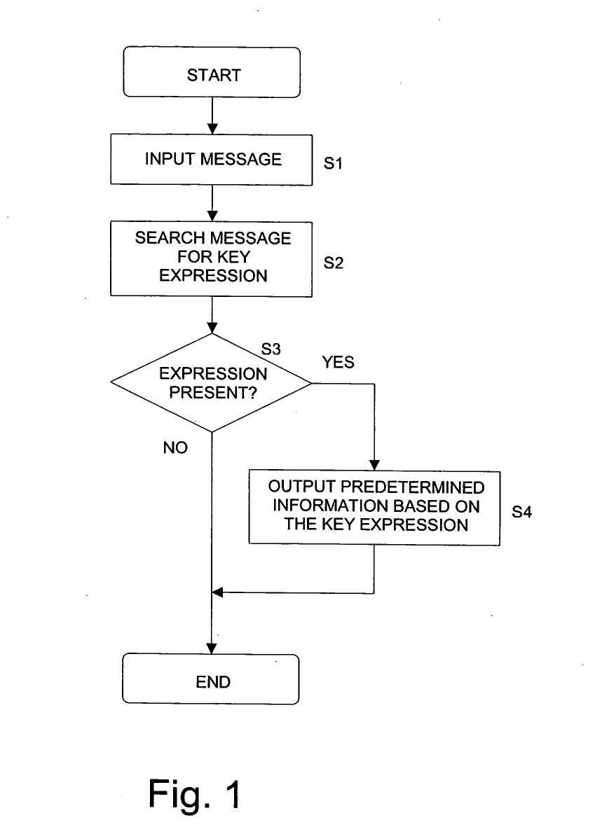

The principle of the invention is described in the following by referring to the flowchart shown in FIG. 1.

In step S1, a message is input in the device carrying out the method. The message may be a message of a subscriber issued during a chat or the like. The device carrying out the method can be a network element which supports the service during which the message is issued. For example, the device may be context specific chat analyser of an IMPS (Instant Messaging and Presence Service) Server (to be described later).

In step S2, the message is searched for a particular key expression. This may be a predetermined word or the like.

In step S3 it is judged whether the expression is present, i.e., whether the predetermined expression was found during the search in step S2.

If the expression is not found, i.e., if the expression is not present in the message, the routing ends without performing any further operation. If, however, the message is found, the routing advances to step S4. In step S4, predetermined information is output in response to the key expression. For example, it may be checked whether there is a specific information for the key expression. If so, the information may be output on the display of the user equipment (UE) of the sender or/and receiver of the message. After this, the routine ends.

The invention is described in the following in more detail by referring to an example wherein according to the present embodiment chat room specific advertisement and chat topic context specific advertisements are enabled.

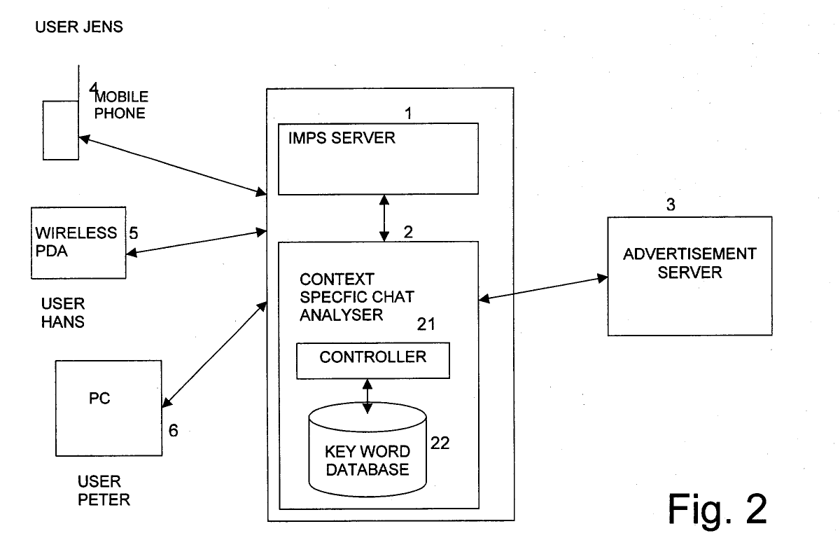

FIG. 2 shows an IMPS architecture (high level) with an additional advertisement server 3. The IMPS architecture comprises an IMPS server 1 comprising an Context specific chat analyser 2 which analyses the chat room topics as well as the chat context of the users. The advertisement server 3 is connected to the IMPS server 2. The users can be either cellular users (phones), as indicated by a mobile station (MS) 4, wireless users (e.g. WLAN PDAs), as indicated by a wireless PDA 5, fixed PC's, as indicated by the PC 6, or other suitable devices.

The context specific chat analyser 2 is adapted to carry out the method as illustrated in FIG. 1. For example, the context specific chat analyser 2 may have a controller 21 (comprising elements such as CPU, RAM, ROM and the like) and a database 22 comprising a table in which the key expressions are stored. Thus, the controller of the context specific chat analyser may send a message to the advertisement server 3 each time a key expression is found. The advertisement server 3 may check whether it has a specific advertisement for the key expression.

The IMPS server 1 may have a monitoring means which issues a command to the context specific chat analyser 2 each time a chat message is received. In response to receiving such a command, the context specific chat analyser 2 starts the routine described above by referring to FIG. 1. Moreover, the IMPS server may be based on OMA (Open Mobile Alliance, former Wireless Village), based on the 3GPP Presence and IMS Messaging or any other IMPS system.

Furthermore, the context specific chat analyser 2 may be included in the IMPS server 1 or may be a separated network element.

As already indicated above, the context specific chat analyser analyses the chat content for key words. Those key words are stored in the associated database, as indicated by reference numeral 22 in FIG. 2. Each chat input from the users is analysed for matches of those key words. Each key word has an associated advertisement or any other content which should be displayed in the chat. The association can be e.g.:

If a word from the user input matches keyword (i) AND keyword (z) then display advertisement (k).

Here, keywords and the advertisement are stored in a array.

There could be other ways, e.g. fuzzy logic could be applied. That is, it could not only be searched for exact matches of the key word(s), but also for matches with similar words (e.g., holidays-vacancy) or different forms of the same word (holiday-holidays).

Moreover, if number of a certain keyword (i) in a chat is bigger then a predetermined number (e.g., 5 times), the advertisement associated with the keyword may be displayed. In this way, the advertisement, is not generated on every occurrence but only after the predetermined expression has occurred for several times. Thus, it is possible to avoid an undesired advertisement in case the predetermined expression is a rather common word (e.g., “street” or the like), for example. Moreover, in this way it can be ensured that the advertisement is shown in case the user shows really interest in the particular item (e.g., three times “pub” in a chat leads to the impression that the user really would like to go out to a pub).

Alternatively, the analysing can be done like in search engines in the internet, e.g.:
1. Search for keywords in the chat
2. Find advertisement for keyword 1 AND keyword 2 AND keyword 3.
3. Display advertisement

That is, in this case no predetermined logical combinations are used, but it is actively searched for a corresponding advertisement (or other content to be displayed).

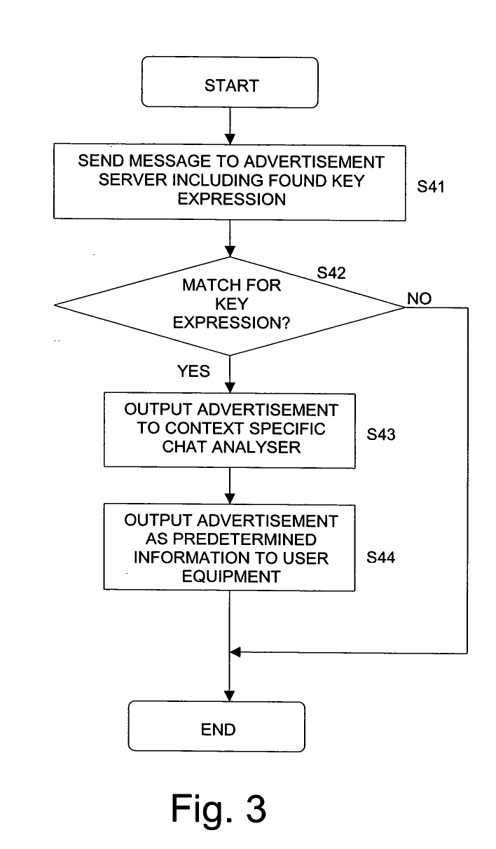

FIG. 3 shows a flowchart of a more detailed procedure carried out in the outputting step S4 of FIG. 1.

The procedure according to FIG. 3 is started when a key expression is found. In step S41, the context specific chat analyser sends a message including the found key expression to the advertisement server. It is noted that the key expression can also contain a plurality of expressions, of which a logical combination thereof is considered. In step S42, the advertisement server searches whether a specific advertisement for the key expression is present, i.e., whether there is a match between the key expression and a specific advertisement. If no, the routine ends without any further operation. That is, although a key expression was found in step S3, no predetermined information (i.e., advertisement) is output.

If yes in step S42, the routine advances to step S43, in which the advertisement server outputs the advertisement to the context specific chat analyser, which sends the received advertisement as the predetermined information to the user equipment(s) of the subscriber(s)(s44). Thereafter, the routine ends.

In the following some examples for the operation of the above-described system are given.

Normally users are chatting with their “buddies” who are online at the moment. Also chat rooms could be created, e.g. by one user or by administrators. Chat rooms have a chat room name which describes also the topic(s) which are discussed in the chat room (e.g. “Stock Market Finland chat room”).

Those chats have a certain topic, which over time (when discussed enough) can change of course.

### EXAMPLE

The chat could be among friends and the topic could be what to do at this Saturday evening. By referring to FIG. 2, it is assumed that user Jens uses the mobile phone (MS) 4, user Hans uses the wireless PDA 5, and user Peter uses the fixed PC 6.
Jens Hi, what should we do Saturday evening?
Peter Let's go to the cinema.
Hans Let's have some Guinness beer tonight.
Jens Well, I would go for drinking and meeting some new people.
Peter But which Irish pub is popular in Helsinki?

With context specific advertisements the IMPS service can be improved. The IMPS server filters out certain key words (i.e., key expressions) from the chat between those people:
Saturday evening
Guinness
Irish pub

This mechanism is performed by the context specific chat analyser 2 (a specific context/word chat analyser), as described above with reference to FIGS. 1 and 2.

Based on this, the IMPS server (i.e., the context specific chat analyser 2) would ask from the advertisement server 3 if the advertisement server has specific advertisements which would match the context criteria/filter (steps S41 to S42):
“Saturday evening” AND “Guinness” AND “Irish pub”.

It is noted that the key expression is in this case a logical combination of different key expressions or key words.

If yes (i.e., the advertisement server has specific advertisements, i.e., yes in step S43)), then the advertisement server gives back a context specific advertisement, e.g. about a new Irish Pub in downtown Helsinki (step S43). The IMPS server forwards this advertisement to the subscribers involved (step S44).

So the above example would be improved by displaying additional advertisements to those IMPS users in that particular chat.

### EXAMPLE

Jens Hi, what should we do Saturday evening?
Peter Let's go to the cinema.
Hans Let's have some Guinness beer tonight.
Jens Well, I would go for drinking and meeting some new people.
Peter But which Irish pub is popular in Helsinki?

Advertisement: “Come and visit the new Irish Pub “GET-DRUNK” in Mannerheimintie 5, Happy Hour between 20-22!”
Jens Should we try out “GET-DRUNK”?
Peter Ok, but let's really get drunk.
Jens Well, I hope there are not only drunken Finnish people ;-)

### 2^{nd} EXAMPLE

Jens: Should we go to see VFB Stuttgart playing against Ajax Amsterdam?
Peter: Yes, I like to see a Champions game. But we have to fly to Stuttgart.
Hans Let's go and see some good European football game!

Advertisement: “LIPPU PALVELU: Special offer. Book your champions league game ticket, plus the flight from us. 50% bonus” Check out www.lippupalvelu.com
Hans Good offer from LIPPU PALVELU.
Jens: Ok, I book the tickets and the flights for us from LIPPU PALVELU.COM
Peter: You can even do it with your I-Mode phone ;-)

Advertisement: “I-Mode phones from TELIA, -60% off, 3 month no charges”
Peter I do it with my I-Mode phone, it's cheaper.

The context specific advertisements could be enhanced if the service would also analyse the language of the chat, e.g. if the chat room is hosted by an English service provider, but the chat is in German language, the advertisement could be in German language as well.

### 3^{rd} EXAMPLE

German language in a chat room hosted by a English IMPS service provider
Hans Gehst Du mit mir heute abend ins ABBA Konzert?
Tina Ja, ich mag ABBA.

Advertisement: “Neue ABBA CD jetzt 50% billiger bei Marktmedium Online.”

It is noted that the above example is also an example for the case in which an advertisement is displayed only when the key word is mentioned in the chat for a certain number of times. Namely, the key word “ABBA” is mentioned here two times, so that the advertisement is displayed only after the second occurrence of the key word.

This service could be also very popular in adult chat rooms, with service offerings from adult content owners.

The above description and accompanying drawings only illustrate the present invention by way of example. Thus, the embodiment may vary within the scope of the attached claims.

For example, according to the above-described embodiment, the messages concerned are text messages. However, the embodiment is not limited thereon, and also voice messages may be analysed. For this, a voice recognizing means is required which recognizes the text such that the message can be searched for the predetermined expressions.

Moreover, the embodiment is directed on IMPS, and in particular to chat messages. However, the invention is also applicable on other messages services, for example SMS (Short Messages Service), MMS (Multimedia Messages Services), e-mail or other suitable messages.

Furthermore, the above embodiment is directed to advertisements. However, also other general information may be included, for example, information regarding traffic. This may be of interest when driving to a particular restaurant or the like.

Moreover, also other messages contents than text or voice may be analysed. For example, an advertisement message or the like may be issued in response to sending a particular data file with a message (e.g., attachment to an e-mail or within a MMS message. For example, it could be analysed whether the attachment comprises an MP3 file, for example, such that an advertisement regarding a music shop can be issued. Apart from advertising, also a warning regarding illegal copies of music may be output.

Furthermore, also an advertisement regarding the artist may be issued.

In addition, in the above embodiment only one advertisement server 3 is shown. However, there may be a plurality of advertisement servers. In this case, the table stored in the database of the context specific chat analyser may also comprise the address of the advertisement server in question.

Moreover, according to the above embodiment, all subscribers involved in the chat receive the advertisement. However, the advertisement may be sent only to a part of the subscriber. For example, sending of advertisement to a particular subscriber may be blocked if he is unwilling to receive such advertisements.

Furthermore, in the above embodiment it is described that only one advertisement matches with the key expression. However, there may be the case that more than one advertisement (or information in general) would match to the key expression. In this case, the different advertisement may all be displayed, which could be acceptable in a small number. Alternatively, different priority levels may be assigned to the advertisement, so that only the advertisement with the highest priority is displayed.

Moreover, the context specific chat analyser may be arranged such that also the advertisement messages are stored in the database. In this case, it is not necessary to access the advertisement servers every time an advertisement information is output. The advertisement servers may only contact the context specific chat analyser in case the advertisement messages are updated. In this way, unnecessary traffic over the network may be avoided.

However, the invention is also applicable with no database in the context specific chat analyser. In this case, the context specific chat analyser always accesses the advertisement server. This way is advantageous in case a fast connection between the context specific chat analyser and the advertisement server is provided, because in this way the key expressions can easily be changed and updated in the advertisement server without the necessity to update the database in the context specific chat analyser.

1. A method for providing context-related information, comprising the steps of
analysing (S1, S2) whether a message contains a predetermined expression, and
in case the predetermined expression is contained in the message, generating (S4) predetermined information based on the predetermined expression.

2. The method according to claim 1, wherein the predetermined expression comprises a specific word or a specific word combination.

3. The method according to claim 1, wherein the predetermined expression comprises a logic combination of different specific words or different specific word combinations.

4. The method according to one of the claims 1 to 3, wherein the message is sent from a user equipment (4, 5, 6) of a subscriber and the predetermined information generated in the generating step is sent to the user equipment.

5. The method according to one of the claims 1 to 4, further comprising the step of displaying the predetermined information on a display means of the user equipment.

6. The method according to one of the claims 1 to 5, wherein a plurality of user equipments (4, 5, 6) of a plurality of subscribers are involved in a communication during which the message is sent, and
in the generating step (S4), the predetermined information is sent to all or a part of the plurality of user equipments.

7. The method according to one of the claims 1 to 6, wherein the message is a text message.

8. The method according to one of the claims 1 to 7, wherein the method is carried out in a network control element providing a messages service.

9. The method according to one of the claims 1 to 8, wherein the generating step comprises the steps of
sending (S41) the key expression to an specific information server,
determining (S42), in the specific information server, whether a specific information is associated to the received key expression,
in case a specific information is associated to the received key expression, outputting (S43, S44) the specific information as the predetermined information.

10. The method according to one of the claims 1 to 9, wherein the predetermined expression is stored in a database (22), and during the analysing step (S1, S2), the database is accessed in order to determine whether the predetermined expression is contained in the message.

11. The method according one of the claims 1 to 10, wherein the generating step (S4) is performed only after the analysing step reveals that the predetermined expression is contained in the message for a predetermined number of time.

12. A network system for providing messages services, comprising a network control element (1), wherein the network control element comprises
means (2) for analysing whether a message received from a subscriber contains a predetermined expression and deciding whether the expression is contained in the message, and
means (2) for generating predetermined information based on the predetermined expression.

13. The network system according to claim 12, wherein the predetermined expression comprises a specific word or a specific word combination.

14. The network system according to one of the claims 12 to 13, wherein the predetermined expression comprises a logic combination of different specific words or different specific word combinations.

15. The network system according to one of the claims 12 to 14, further comprising a user equipment (4, 5, 6) of a subscriber,
wherein the user equipment (4, 5, 6) comprises means for sending a message to the network control element, and the network control element comprises means for sending the predetermined information to the user equipment.

16. The network system according to one of the claims 12 to 15, wherein the user equipment comprises means for displaying the predetermined information.

17. The network system according to one of the claims 12 to 16, further comprising a plurality of user equipments (4, 5, 6) of a plurality of subscribers, wherein
the network control element (1) comprises means for sending the predetermined information to all or a part of the plurality of user equipments.

18. The network system according to one of the claims 12 to 17, wherein the message is a text message.

19. The network system according to one of the claims 12 to 18, further comprising a specific information server (3), wherein
the network control element (1) comprises means for sending the key expression to the specific information server,
the specific information server (3) comprises means for determining whether a specific information is associated to the received key expression, and for outputting the specific information as the predetermined information to the network control element (1), in case a specific information is associated to the received key expression.

20. The network system according to one of the claims 12 to 19, wherein analysing means (2) of the network control element (1) comprises a database (22) for storing the predetermined expression, and the analysing means (2) is adapted to access the database (22) in order to determine whether the predetermined expression is contained in the message.

21. The network system according to one of the claims 12 to 20, wherein the generating means (2) is adapted to generate the predetermined information only after the analysing means has determined that the predetermined expression is contained in the message for a predetermined number of time.
